(19) United States
(12) Patent Application Publication
(10) Pub. No.: US 2002/0051035 A1
(43) Pub. Date: May 2, 2002

(54) A METHOD OF MANUFACTURING AN INK JET HEAD

(76) Inventor: TAKUMI SUZUKI, YOKOHAMA-SHI (JP)

Correspondence Address: FITZPATRICK CELLA HARPER & SCINTO, 30 ROCKEFELLER PLAZA, NEW YORK, NY, 10112, US

(21) Appl. No.: 09/097,729

(22) Filed: Jun. 16, 1998

(30) Foreign Application Priority Data
Jun. 19, 1997 (JP) 9-162797

(51) Int. Cl. B41J 2/145; B41J 2/15

(52) U.S. Cl. 347/50; 29/890.1; 347/40; 29/412

(57) ABSTRACT

When very high mounting accuracy is required in the mounting of an ink jet head onto a support member, desired positional accuracy can be achieved relatively easily and a reduction in cost resulting from the simplification of the steps of process is achieved. At least two heads are aligned with each other and are joined or adhesively secured to a wiring substrate having an external connecting terminal formed with a lead, and the wiring substrate is cut at least each two heads, whereafter the cut segments are mounted as a unit on a support member.

### BACKGROUND OF THE INVENTION

1. Field of the Invention

This invention relates to an ink jet head carrying thereon a plurality of base plates for the ink jet head, and a method of manufacturing the same.

2. Related Background Art

An ink jet head according to the prior art is connected to a connecting substrate having wiring provided on a tape by ultrasonic wave, heat or the like, but when as in a head for coping with color printing, it is necessary to make two or more kinds of ink adhere to a matter to be printed, there are a method of providing a partition in a head and discharging a plurality of inks, and a method of arranging heads corresponding to a plurality of inks and discharging the inks. In the case of a head capable of discharging a plurality of inks discretely in a single head, it is possible to effect alignment for each color completely by a photomask during patterning. However, in the case of a color head using a method of preparing a head for each color and arranging the heads, the deviation allowed during the alignment of the heads becomes smaller as the resolution of printing becomes higher, and it is required to mount the heads actually highly accurately. For example, in the case of conventional 360 DPI, the dot pitch of discharge nozzles is of the order of 70 μm and therefore, the diameter of ink when the ink has arrived at the matter to be printed becomes 80 to 90 μm and the accuracy necessary for alignment is of the order of ±10 μm. In the case of this degree of accuracy, alignment in θ, x-y and z directions is sufficiently possible. However, as the recent tendency, heads of density double that in the prior art, i.e., as high resolution as 600 to 720 DPI are becoming the mainstream. Therefore, the dot pitch of discharge nozzles is 35 to 40 μm and the accuracy necessary for alignment has become ±2 to ±5 μm.

So, when a head is used for each color as in the prior art, it is necessary to mount the heads highly accurately in all of θ, x, y and z directions. However, the prior-art mounting method adopts a method of image-processing the position of a head having a chip connected to an external electrode, and then securing it by resin or the like. Therefore, it is necessary to hold or press the head so as not to move for the time until the resin is hardened. However, to achieve a reduction in cost, if the size of the head becomes small, it is difficult to secure a space for effecting the pressing, and it is difficult to effect highly accurate mounting reliably.

### SUMMARY OF THE INVENTION

The inventor has concentrated his energizes to solve the above-noted problem and as the result, he has found that if at least two heads are aligned with each other and are joined or adhered to a wiring substrate having an external connecting terminal formed with a lead and said substrate is cut for at least each two or more heads, whereafter an ink jet head is made with the cut segments mounted as a unit on a support member, desired positional accuracy can be achieved relatively easily even when high mounting accuracy as in a color printer of high resolution is required, and has come to complete this invention.

### BRIEF DESCRIPTION OF THE DRAWINGS

FIGS. 1A, 1B and 1C are views for illustrating an embodiment of the present invention, FIG. 1A being a plan view during the actual mounting of TAB, FIG. 1B being a plan view in a state in which the TAB of FIG. 1A has been cut for each three heads, and FIG. 1C being a side view of a head unit completed with the TAB of FIG. 1B cut for each three heads being cemented to a support member 6.

FIGS. 2A and 2B illustrate the inconvenience in the actually mounting method according to the prior art, FIG. 2A being a plan view, and FIG. 2B being a side view.

FIG. 3 is a schematic view illustrating another embodiment of the present invention.

FIG. 4 is a schematic view illustrating still another embodiment of the present invention.

FIGS. 5A, 5B and 5C are schematic views illustrating another embodiment of the present invention, FIG. 5A showing a wiring substrate 5 formed with leads, FIG. 5B showing a support member 6 on which heads 1, 2 and 3 are installed, and FIG. 5C showing a state in which FIGS. 5A and 5B have been put together.

### DESCRIPTION OF THE PREFERRED EMBODIMENTS

The present invention particularly provides a mounting method which is good in the positional accuracy of an ink jet head of high resolution in manufacturing an ink jet head in which as a method of connecting a lead with an electrode to be taken out to the outside, lead connection comprising connecting the lead by heat, ultrasonic wave or the like has been effected.

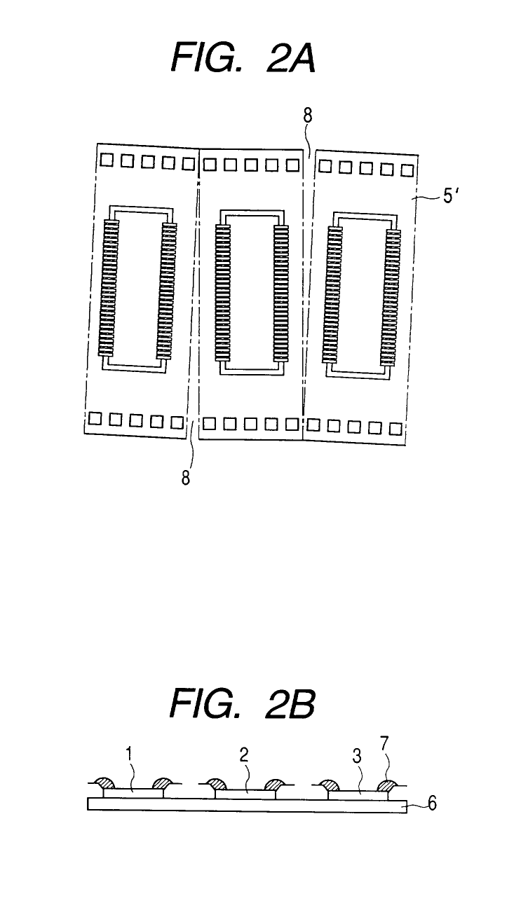

Heretofore, as shown in FIGS. 2A and 2B, each wiring substrate 5′ carrying a head thereon has been aligned with a support member 6 to thereby manufacture an ink jet head having a plurality of heads and therefore, such deviations 8 as shown in FIG. 2A have been created and it has been difficult to mount the head with good positional accuracy.

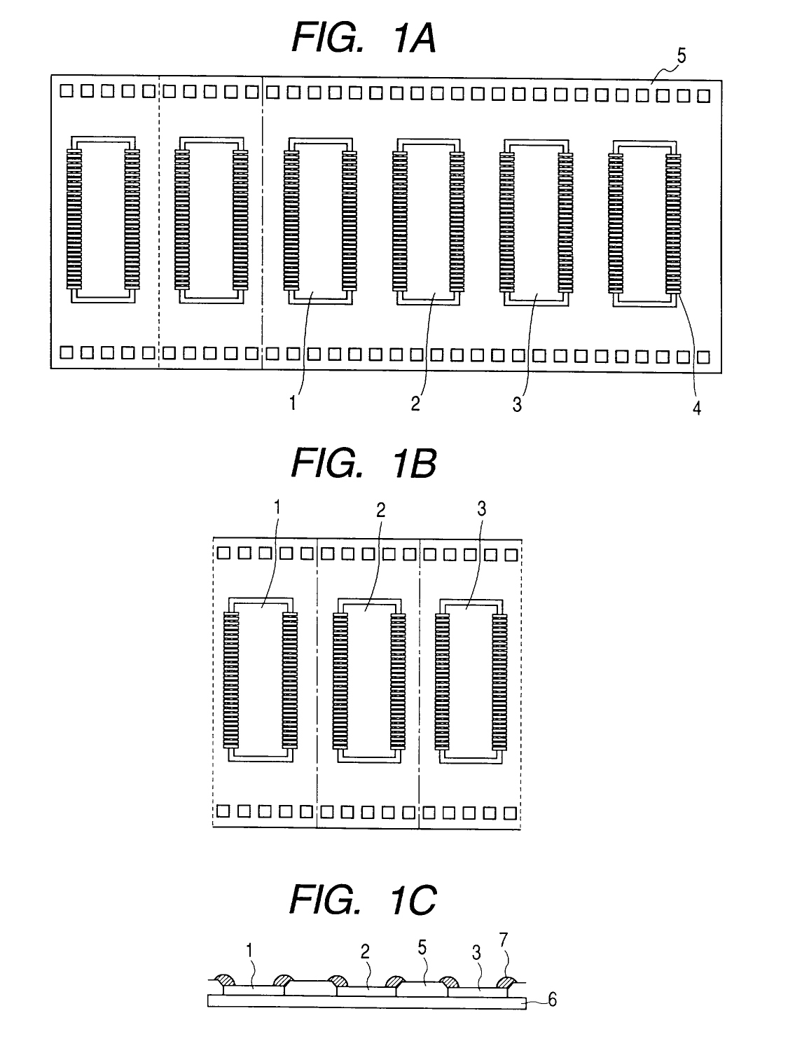

In contrast, in FIGS. 1A to 1C which are conceptual views for illustrating an embodiment of the present invention, an ink jet head formed in a wafer state is subjected to the dicing by a blade as in the prior art to make each chip. These chips are disposed on a jig in a desired positional relation and are mounted on a mounting apparatus for a wiring substrate such as TAB, whereafter they are electrically joined to the wiring substrate. Thereafter, sealing resin 7 for making up for the insulativeness and joint strength of the joined portion is applied to the electrically joined portion and is hardened (FIG. 1A). If during the mounting of this TAB, heads for colors (a head Y(1), a head M(2) and a head C(3)) are successively mounted and thereafter, this TAB is cut for each three heads (FIG. 1B), there will be formed a head unit in which heads are disposed for colors. An ordinary TAB mounting apparatus is provided with a device for detecting the positions of chips to be loaded thereon, and an angle θ and vertical and horizontal deviations X and Y are corrected so as to become proper, and if the chips are mounted by this apparatus, alignment of accuracy of the order of ±2 to ±8 μm becomes capable of being effected easily. The unit formed in this manner is put into a mold and transfer mold formation is effected by mold resin, whereby the head unit of the present invention is completed. Also, if the transfer mold is not effected, this unit is intactly stuck on a base plate 6 as shown in FIG. 1C, whereby the head unit of the present invention is completed. Reference numeral 4 designates leads, Reference numeral 5 denotes a wiring substrate (TAB: tape automated bonding), and Reference numeral 6 designates a support member.

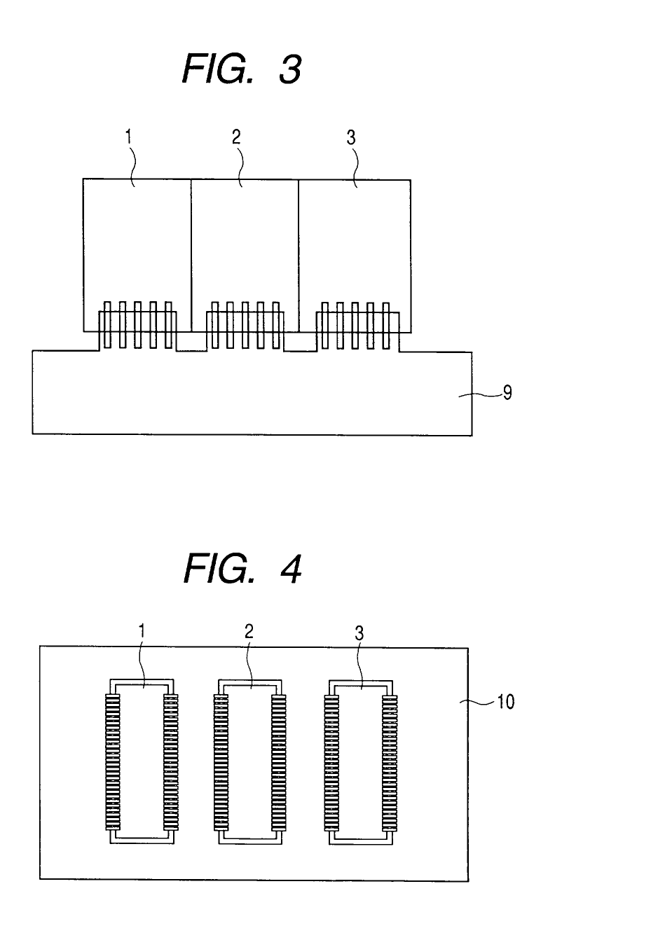

FIG. 3 shows another embodiment of the present invention. An ink jet head formed in a wafer state is subjected to the dicing by a blade to make each chip. These chips are loaded onto a mounting apparatus to a flexible printed plate in the same manner as in the above-described embodiment. If during the mounting onto this flexible printed plate, heads for colors (a head Y(1), a head M(2) and a head C(3)) are successively loaded thereon, whereby this flexible printed plate 9 is cut for each three heads, there will be formed a head unit in which the heads are disposed for colors. An ordinary flexible printed plate mounting apparatus is provided with a device for detecting the positions of the chips to be loaded thereon, and an angle θ and vertical and horizontal deviations X and Y are corrected so as to become proper, and if the chips are mounted by this apparatus, a position of accuracy of the order of ±2 to ±8 μm can be simply provided. If the unit formed in this manner is put into a mold and transfer molding is effected by mold resin, the head unit of the present invention will be completed. When the transfer molding is not effected, this unit is intactly stuck on a base plate, whereby the head of the present invention is completed.

FIG. 4 shows still another embodiment of the present invention. An ink jet head formed in a wafer state is subjected to the dicing by a blade to make each chip. These chips are loaded onto a mounting apparatus to aramid resin-impregnated paper wiring base plate in the same manner as in the above-described embodiments. If during the mounting of this aramid resin-impregnated paper wiring substrate, heads for colors (a head Y(1), a head M(2) and a head C(3)) are successively mounted to thereby cut this aramid resin-impregnated paper wiring substrate 10 for each three heads, there will be formed a head unit in which the heads are disposed for the colors. An ordinary aramid resin-impregnated paper wiring substrate mounting apparatus is provided with a device for detecting the positions of the chips loaded thereon, and an angle θ and vertical and horizontal deviations X and Y are corrected so as to become proper, and if the chips are mounted by this apparatus, alignment of accuracy of the order of ±2 to ±8 μm becomes capable of being effected easily.

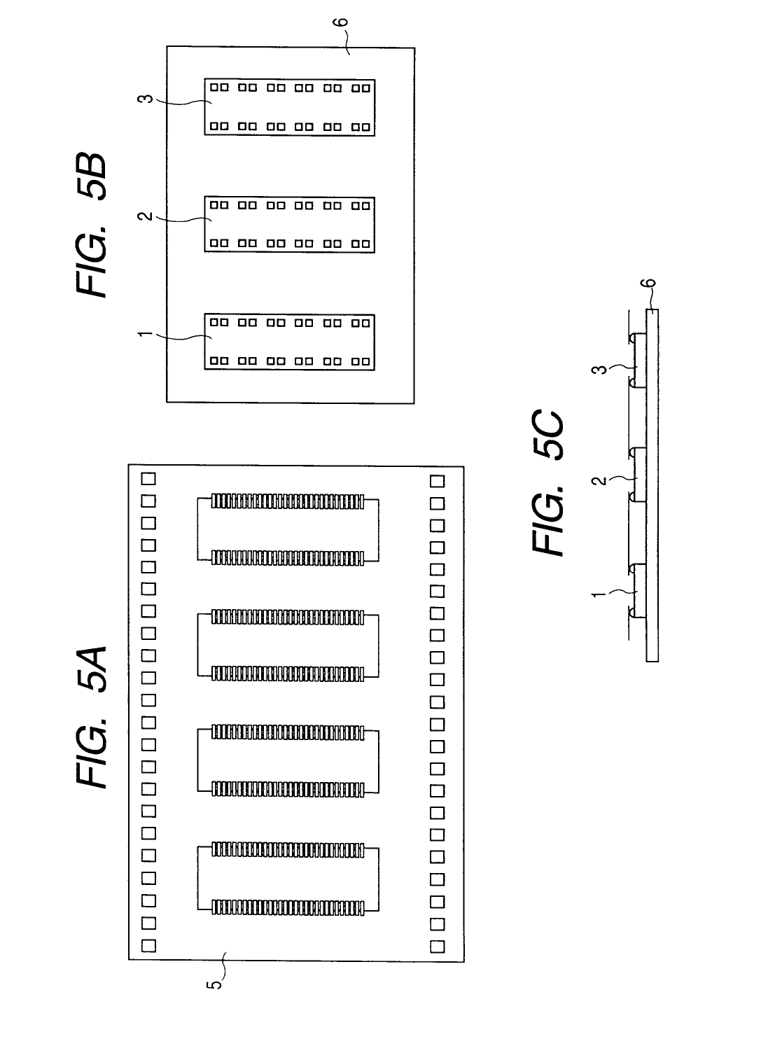

FIGS. 5A to 5C show yet still another embodiment of the present invention. FIG. 5A shows a wiring substrate 5 formed with leads, FIG. 5B shows a support member 6 on which heads 1, 2 and 3 are installed, and FIG. 5C shows a state in which FIGS. 5A and 5B have been put together. A head unit completed in a wafer state was subjected to the dicing by a blade and was separated into individual segments, whereafter X, Y and θ are controlled, and the head was mounted on a support base plate 6 such as a polyimide base plate, an Si base plate or aramid-impregnated paper of which the coefficient of thermal expansion is equal or approximate to that of the chips (FIG. 5B), and was joined to a base member (FIG. 5A) comprising aramid-impregnated paper formed with wiring. By doing so, the deviation of the position caused by the heating (usually 130 to 200° C.) of a chip stage in the joint in a state in which the coefficient of thermal expansion of the support base plate on which the head is mounted is smaller than or equal to that of a wiring substrate used for electrode joint can be corrected and joint can be done at 1 to 8 μm together with the accuracy of mounting. Also, in this case, a sufficient margin can be secured on the outer peripheral portion of the chips and therefore, it becomes possible to tentatively harden the chips by the use of photo-curing resin, and it also becomes possible to effect positioning without holding down the chips or with the time for holding down the chips minimized. Thereafter, in order to improve the insulativeness of the joined portion and make up for the strength of the joined portion, sealing is effected by sealing resin. Further, the head unit made in this manner is adhered to a base plate to thereby complete the head of the present invention.

In the embodiment shown in FIGS. 5A to 5C, the method is comprised of the step of adhering at least two or more heads to a support member, and thereafter joining the electrodes of the head to a wiring substrate.

That is, a plurality of heads of which the alignment has been precisely effected are arranged on a support member and are adhered to the latter. These are electrically joined to a wiring substrate comprising TAB, a flexible printed plate or aramid-impregnated paper formed with wiring, by heat, ultrasonic wave or the like. After the electrical joint has been done, the wiring substrate is cut, and when the support member is adhered to a base member formed with an ink flow path, the head of the present invention is completed.

As described above, according to the present invention, the highly accurate mounting of a plurality of heads is effected during electrode joining and therefore, desired positional accuracy can be achieved relatively easily even when very high mounting accuracy is required as in a color printer of high resolution and also, the manufacturing process is simplified and this contributes to a reduction in the cost of the printer.

What is claimed is:

1. An ink jet head characterized in that at least two or more heads are aligned and are joined or adhesively secured to a single wiring substrate having an external connecting terminal formed with a lead and said base member is cut for at least each two or more heads, whereafter the cut segments are mounted as a unit on a support member.

2. An ink jet head according to claim 1, characterized in that the wiring substrate having the external connecting terminal is TAB.

3. An ink jet head according to claim 1, characterized in that the wiring substrate having the external connecting terminal is a flexible printed plate.

4. An ink jet head according to claim 1, characterized in that the wiring substrate having the external connecting terminal is aramid-impregnated paper.

5. An ink jet head according to claim 1, characterized in that said support member is a polyimide plate.

6. An ink jet head according to claim 1, characterized in that said support member is an Si plate.

7. An ink jet head according to claim 1, characterized in that the coefficient of thermal expansion of said support member is equal or approximate to the coefficient of thermal expansion of the heads.

8. An ink jet head according to claim 7, characterized in that said support member is aramid-impregnated paper.

9. A method of manufacturing an ink jet head characterized by aligning at least two or more heads on a jig, thereafter joining or adhering said heads to a single wiring substrate having a plurality of external connecting terminal portions corresponding to said heads formed with a lead, cutting said wiring substrate for at least each two or more heads, and mounting said cut segments as a unit on a support member.

10. A method of manufacturing an ink jet head according to claim 9, characterized by executing the terminal joining step after having adhesively secured the heads to the wiring substrate and before executing the cutting.

11. A method of manufacturing an ink jet head according to claim 9, characterized by adhering the heads to said wiring substrate after having executed the step of joining the heads to the terminals of said wiring substrate and before executing the cutting.

12. A method of manufacturing an ink jet head according to claim 9, characterized in that the wiring substrate having the external connecting terminal portions is TAB.

13. A method of manufacturing an ink jet head according to claim 9, characterized in that the wiring substrate having the external connecting terminal portions is a flexible printed plate.

14. A method of manufacturing an ink jet head according to claim 9, characterized in that the wiring substrate having the external connecting terminal portions is aramid-impregnated paper.

15. A method of manufacturing an ink jet head according to claim 9, characterized in that said support member is a polyimide plate.

16. A method of manufacturing an ink jet head according to claim 9, characterized in that said support member is an Si plate.

17. A method of manufacturing an ink jet head according to claim 9, characterized in that the coefficient of thermal expansion of said support member is equal or approximate to the coefficient of thermal expansion of the heads.

18. A method of manufacturing an ink jet head according to claim 17, characterized in that said support member is aramid-impregnated paper.

19. An ink jet head characterized in that at least two or more heads are aligned and are adhesively secured to a support member, whereafter said heads are joined to a wiring substrate and thereby mounted.

20. An ink jet head according to claim 19, characterized in that the wiring substrate having an external connecting terminal is TAB.

21. An ink jet head according to claim 19, characterized in that the wiring substrate having an external connecting terminal is a flexible printed plate.

22. An ink jet head according to claim 19, characterized in that the wiring substrate having an external connecting terminal is aramid-impregnated paper.

23. An ink jet head according to claim 19, characterized in that said support member is a polyimide plate.

24. An ink jet head according to claim 19, characterized in that said support member is an Si plate.

25. An ink jet head according to claim 19, characterized in that the coefficient of thermal expansion of said support member is equal or approximate to the coefficient of thermal expansion of the heads.

26. A method of manufacturing an ink jet head characterized by aligning at least two or more heads on a support member and adhering said heads to the support member, and thereafter joining said heads to a single wiring substrate having a plurality of external connecting terminal portions corresponding to said heads formed with a lead to thereby mount said heads.

27. A method of manufacturing an ink jet head according to claim 26, characterized in that the wiring substrate having the external connecting terminal portions is TAB.

28. A method of manufacturing an ink jet head according to claim 26, characterized in that the wiring substrate having the external connecting terminal portions is a flexible printed plate.

29. A method of manufacturing an ink jet head according to claim 26, characterized in that the wiring substrate having the external connecting terminal portions is aramid-impregnated paper.

30. A method of manufacturing an ink jet head according to claim 26, characterized in that said support member is a polyimide plate.

31. A method of manufacturing an ink jet head according to claim 26, characterized in that said support member is an Si plate.

32. A method of manufacturing an ink jet head according to claim 26, characterized in that the coefficient of thermal expansion of said support member is equal or approximate to the coefficient of thermal expansion of the heads.
